(19) United States
(12) Patent Application Publication
(10) Pub. No.: US 2013/0241206 A1
(43) Pub. Date: Sep. 19, 2013

(54) APPARATUS AND METHOD FOR GENERATING POWER FROM A FLUID CURRENT

(71) Applicant: Mike Tkadlec, Oakdale, MN (US)

(72) Inventor: Mike Tkadlec, Oakdale, MN (US)

(73) Assignee: Future Force, LLC, Roseville, MN (US)

(21) Appl. No.: 13/821,355

(22) PCT Filed: Sep. 9, 2011
(86) PCT No.: PCT/US11/51010

§ 371 Date: Jun. 6, 2013

Related U.S. Application Data
(60) Provisional application No. 61/381,652, filed on Sep. 10, 2010.

(51) Int. Cl. H02K 7/18

(52) U.S. Cl. CPC H02K 7/1807
USPC 290/54

(57) ABSTRACT

An apparatus and method for generating power from a fluid current. The apparatus can include a power drive assembly (200) for converting the flowing energy of a fluid current into rotational energy, an acceleration chamber (106) configured to increase an entering flow of fluid to an accelerated flow, and pontoons (102) for supporting at least a portion of the power drive assembly in the acceleration chamber, such that the power drive assembly is positioned to receive the flowing energy of the accelerated flow. The method may include accelerating a flow of fluid to an accelerated flow, positioning at least a portion of a power drive assembly within the accelerated flow, the power drive assembly configured for converting the flowing energy of a fluid current into rotational energy, and supporting the power drive assembly with pontoons, such that the power drive assembly may be floated on a moving body of fluid.

### CROSS REFERENCE TO RELATED APPLICATION

This application claims priority to U.S. Provisional Patent Application No. 61/381,652, filed on Sep. 10, 2010, the entire contents of which are hereby incorporated herein by reference in their entirety.

### FIELD OF THE INVENTION

The present disclosure relates to generating power from a fluid current. More particularly, the present disclosure relates to an apparatus and method for generating power from an accelerated fluid current.

### BRIEF SUMMARY OF THE INVENTION

The present disclosure, in one embodiment, relates to an apparatus for generating power from a fluid current. The apparatus can include a power drive assembly for converting the flowing energy of a fluid current into rotational energy and the rotational energy into electrical energy, an acceleration chamber configured to increase an entering flow of fluid to an accelerated flow, and one or more pontoons for supporting at least a portion of the power drive assembly in the acceleration chamber, such that the power drive assembly is positioned to receive the flowing energy of the accelerated flow. In some embodiments, the power drive assembly may include a paddle wheel or Pelton wheel supported to receive the flowing energy of the accelerated flow. A magnetic drive assembly may be operably coupled with the paddle wheel or Pelton wheel. In other embodiments, the power drive assembly may include any suitable means for transforming the flowing energy of the accelerated flow into rotational energy of a drive axis, at least a portion of the means for transforming being supported to receive the flowing energy of the accelerated flow. In further embodiments, the acceleration chamber may have an opening at a first end which narrows in cross-sectional area toward a second end, thus increasing the flow of fluid from the first end to the second. The power drive assembly may further include a magnetic drive assembly operably coupled with the drive axis, and in some embodiments, the magnetic drive assembly includes a drive magnet and a motion magnet, the drive magnet and motion magnet, due to at least one of their attractive or repelling forces, working in conjunction to gear up the rotational energy of the drive axis. The drive magnet may be supported for rotation about the drive axis, and the motion magnet may be supported for rotation about an output axis, the rotation of the motion magnet about the output axis driving the output axis. The power drive assembly may also include a generator operably coupled with the output axis for generating the electrical energy.

The present disclosure, in another embodiment, relates to a method for generating power from a fluid current. The method includes accelerating a flow of fluid to an accelerated flow, positioning at least a portion of a power drive assembly within the accelerated flow, the power drive assembly configured for converting the flowing energy of a fluid current into rotational energy and the rotational energy into electrical energy, and supporting the power drive assembly with pontoons, such that the power drive assembly may be floated on a moving body of fluid. In some embodiments, the power drive assembly may include a paddle wheel or Pelton wheel supported to receive the flowing energy of the accelerated flow. The power drive assembly may also include a magnetic drive assembly operably coupled with the paddle wheel or Pelton wheel. The acceleration chamber may have an opening at a first end which narrows in cross-sectional area toward a second end, thus increasing the flow of fluid from the first end to the second. In other embodiments, the power drive assembly may include any suitable means for transforming the flowing energy of the accelerated flow into rotational energy of a drive axis, at least a portion of the means for transforming supported to receive the flowing energy of the accelerated flow. The power drive assembly may accordingly include a magnetic drive assembly operably coupled with the drive axis. In some embodiments, the magnetic drive assembly comprises a drive magnet supported for rotation about the drive axis and a motion magnet supported for rotation about an output axis. The drive magnet and motion magnet, due to at least one of their attractive or repelling forces, may work in conjunction to gear up the rotational energy of the drive axis as output on the output axis. The power drive assembly may also have a generator operably coupled with the output axis for generating the electrical energy.

While multiple embodiments are disclosed, still other embodiments of the present disclosure will become apparent to those skilled in the art from the following detailed description, which shows and describes illustrative embodiments of the disclosure. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the various embodiments of the present disclosure, it is believed that the embodiments will be better understood from the following description taken in conjunction with the accompanying Figures, in which:

FIG. 1 is a perspective view of a pontoon assembly according to one embodiment of the present disclosure.

FIG. 2 is a perspective view of a power drive according to one embodiment of the present disclosure.

FIG. 3 is a perspective view of a pontoon assembly and power drive according to one embodiment of the present disclosure.

FIG. 4 is a perspective view of a powertoon according to one embodiment of the present disclosure.

FIG. 5 is a flow diagram of the acceleration chamber according to one embodiment of the present disclosure.

FIG. 6 is a side view of one embodiment of a magnetic drive assembly usable with the various embodiments of the present disclosure.

FIG. 7A is a schematic view of multiple drive hubs and rotating hubs wherein motion and drive magnets are in the same orientation along their respective drive and motion axes.

FIG. 7B is a schematic view of multiple drive hubs and rotating hubs wherein the motion and drive magnets are in an offset or helical orientation along their respective drive and motion axes.

FIGS. 8A-C include several views illustrating one embodiment of a drive assembly usable with the various embodiments of the present disclosure, showing the generation of the acceleration field.

### DETAILED DESCRIPTION

The present disclosure relates to novel and advantageous apparatus and methods for generating power from a fluid current. More particularly, the present disclosure relates to novel and advantageous apparatus and methods for generating power from an accelerated fluid current. While not limited by such label, an apparatus according to the present disclosure may be referred to herein as a pontoon, powertoon, or powerbarge.

Example uses of the various embodiments of apparatus and methods disclosed herein can include, but are not limited to, use as a personal or private generator, a residential generator, a backup generator, a generator for disaster relief aid, military generator, portable generator, etc. The size, configuration, and power output of the various embodiments of apparatus of the present disclosure can be modified or configured for generally any use.

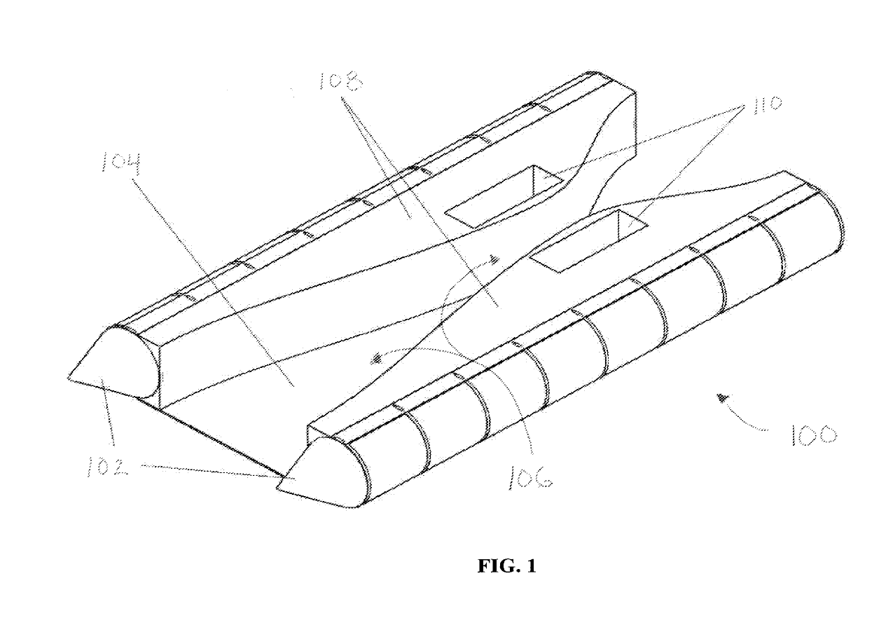

The apparatus according to one embodiment of the present disclosure may be designed to sit in a body of moving water, such as but not limited to, a river, stream, canal, irrigation channel, etc. As shown, in FIG. 1, an apparatus 100 or powertoon according to one embodiment of the present disclosure can include a pontoon assembly having one or more pontoons 102. As shown in FIG. 1, the powertoon 100 may include at least two pontoons for structural support and stability. The pontoons can be made of any suitable material such as but not limited to aluminum, carbon-fiber, engineering plastic, composites, suitable inflatable material, or combinations thereof. Accordingly, the pontoons 102 can be substantially rigid or may be inflatable, or any variation therebetween. The powertoon 100 may further include a bottom deck 104. The bottom deck 104 may extend generally across the pontoons 102 and may add structural integrity to the overall apparatus 100. The bottom deck 104 may also form part of the fluid accelerator, or acceleration chamber 106.

According to one embodiment of the present disclosure, a fluid acceleration chamber 106 may include side walls 108 and/or other components that can cause the fluid flowing within the acceleration chamber to accelerate from its initial flow velocity. The side walls 108 or other components can be made from any suitable material, such as the materials described above with respect to the pontoons 102, or may be made from any other suitable material, such as but not limited to foam, fiberglass, or combinations thereof, such as foam with a fiberglass shell. The acceleration chamber 106 or side walls 108 or other components can further assist in the overall buoyancy of the powertoon 100. Generally, however, the material used should be strong enough to withstand the pressure of the fluid flow without substantially collapsing or breaking. The side walls 108 of the acceleration chamber 106 may further include wells 110, which may be substantially watertight. As will be discussed further below, a portion of the power drive of the powertoon 100 may be fit within the wells 110.

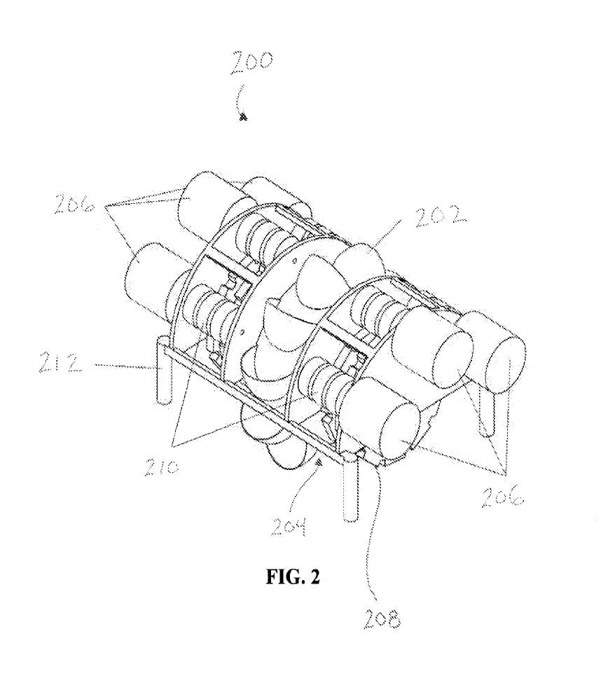

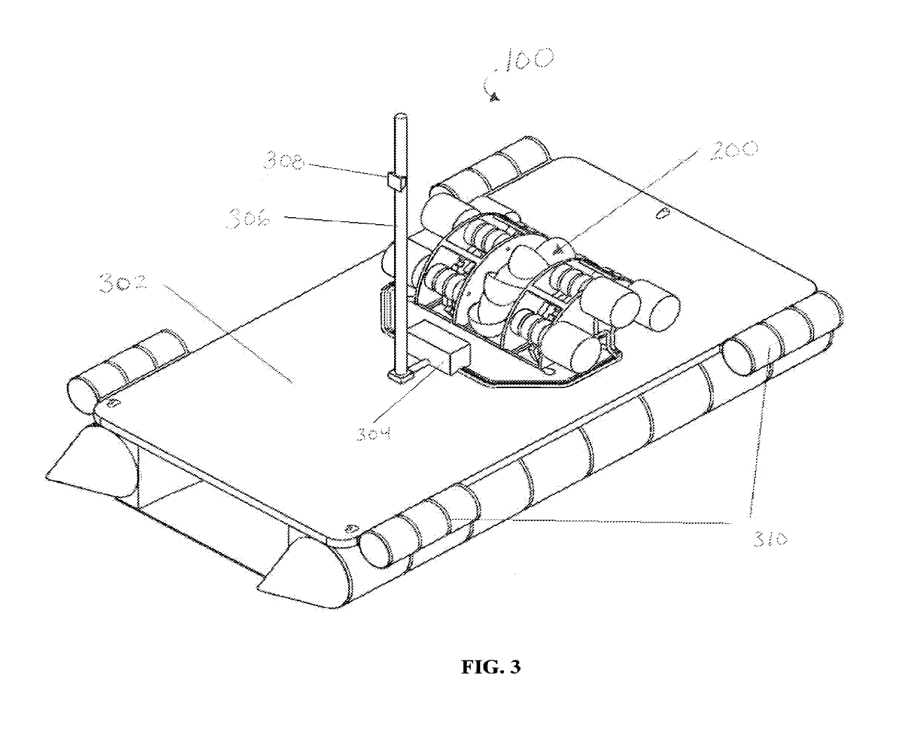

As shown in FIG. 2, the powertoon 100 may include a power drive 200. The power drive 200 may be any suitable power drive system for translating fluid motion to generated power. In one embodiment, the power drive 200 may include means for converting the flowing energy of the fluid to rotational energy. In some embodiments, a paddle-wheel, Pelton wheel 202, or similar mechanism may be used. More specifically, the wheel 202 or suitable alternative can be used to capture the accelerated velocity of the flowing fluid within the acceleration chamber 106 and convert that energy into rotational energy.

In one embodiment, the power drive 200 may also include a magnetic drive assembly or gear assembly, which in some embodiments may be similar to the various embodiments of magnetic propulsion motors described in U.S. Pat. No. 7,385,325, U.S. Pat. No. 7,777,377, and U.S. Publ. No. 2010-0156223, which are hereby incorporated by reference herein in their entirety. In some embodiments, such motors may be modified specifically for use in the various embodiments of powertoons 100 described herein. In general, the rotational energy of the wheel 202 or suitable alternative can be transferred to a magnetic drive assembly 204, such as or similar to the assemblies described in U.S. Pat. No. 7,385,325, U.S. Pat. No. 7,777,377, and U.S. Publ. No. 2010-0156223. In general, a magnetic drive assembly 204 may include drive magnets and motion magnets that, due to their attracting and/or repelling forces, work in conjunction to create rotational energy that, in some embodiments, may be used to drive generators and create electrical power. More specifically, output of power and/or torque may be obtained from rotating the motion magnets through one or more magnetic acceleration fields created by the drive magnets.

According to an embodiment disclosed herein, in general, the magnetic drive assembly 204 or other suitable drive assembly can be used for increasing, or gearing up, the rotational speed of the wheel 204 to an appropriate speed for one or more electric generators 206. In one embodiment, as illustrated in FIG. 2, the magnetic drive assembly 204 or other suitable drive assembly may be split into two sections with the wheel 202 generally located in the center and connected by a central shaft. In one embodiment, as the wheel 202 rotates, so will one or more relatively lower speed rotors 208 of the magnetic drive assembly 204, which in turn will rotate one or more relatively higher speed rotors 210 of the magnetic drive assembly 204. The higher speed rotors 210 of the magnetic drive assembly 204 can provide adequate RPM and torque to the electrical generators 206. The generators can provide either DC or AC power.

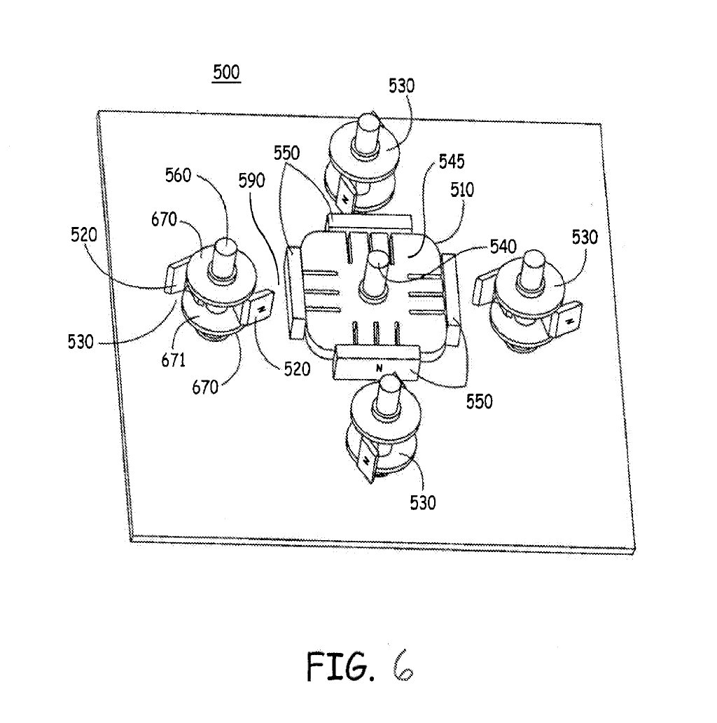

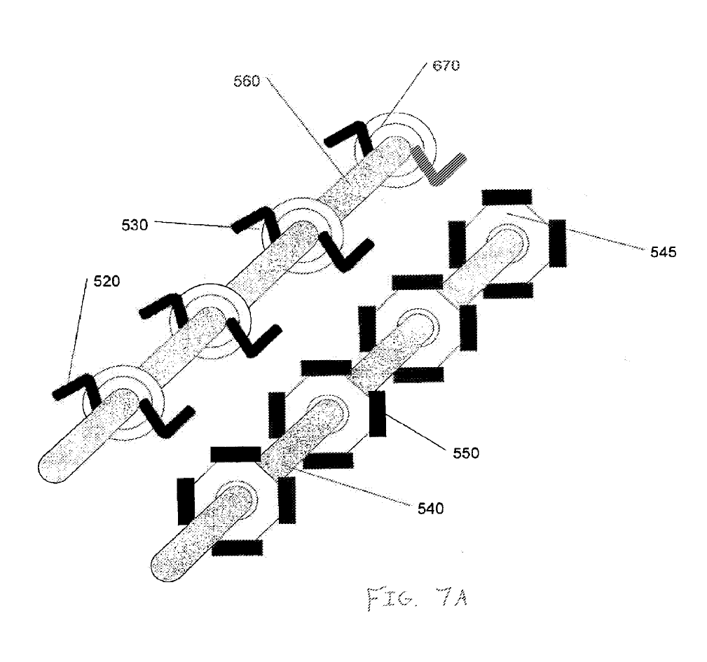

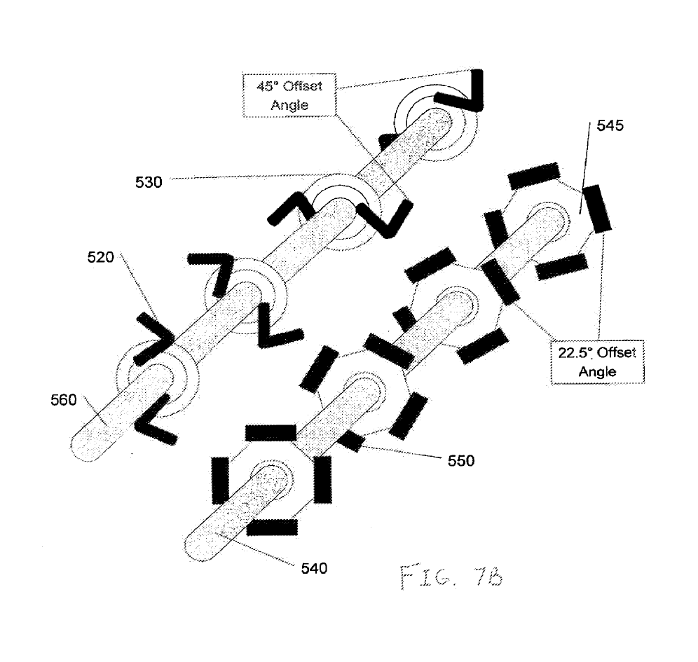

More specifically, FIG. 6 depicts a particular embodiment of a magnetic drive assembly suitable for the various embodiments of powertoons 100 of the present disclosure. As shown, a magnetic drive assembly 500 may contain at least one motion magnet 520 coupled to a motion hub 530. A motion hub 530 may be rotationally coupled to a motion axle 560. A motion hub 530 may comprise at least one attachment base 670, which projects laterally from the motion axle 560 and may be a point of attachment for one or more motion magnets 520, thus securing the motion magnets 520 in the proper orientation. In this example embodiment, a motion magnet 520 may be attached to the inner surfaces 671 of two attachment bases 670 at one or more points on the upper and lower edge surfaces of the motion magnet 520. Various other methods of securing the motion magnets 520 in the proper orientation are possible, for example, attachment of motion magnets directly to the motion axle 560, or attachment of motion magnets to one or more extension arms that are attached to one or more attachment bases 670 or directly to the motion axle 560.

The rotation of the rotating motion hub causes each motion magnet 520 to pass through a magnetic acceleration field 590 created by an acceleration field generator 510. An acceleration field generator 510 may contain a drive axle 540, and a rotating drive hub 545 rotatably coupled to the drive axle 540. and at least one drive or “push” magnet 550, which may be typically located along and attached to the outer circumference of the drive hub 545. In this example embodiment, the drive magnets 550 are attached directly to the drive hub 545, but various other methods of attachment of the magnets 550 to the drive hub 545 are possible, such as securing drive magnets 550 into magnet cradles attached to a drive hub 545. The drive magnets 550 are thus secured to the drive hub 545 in an orientation suitable to create one or more acceleration fields 590. Other methods of securing drive magnets 550 in the proper orientation are possible, such as securing the drive magnets 550 to one or more extension arms, for example.

Output motion axles 560 and input drive axle 540 are illustrated generally parallel to each other such that drive hub 545 generally rotates in the same rotation plane as motion hub 530. However, in other embodiments, the input drive axles may be positioned at other angles with respect to the motion axle. For example, in some embodiments, the input drive axles may be positioned generally at right angles to the motion axle, with the output force substantially at a 90° or perpendicular direction relative to the input force, as further described in U.S. Pat. No. 7,385,325, U.S. Pat. No. 7,777,377, and U.S. Publ. No. 2010-0156223.

Each motion hub 530 may have one or more motion magnets 520 attached thereto, and each drive hub 545 may have one or more drive magnets 550 attached thereto. In one embodiment, the motion hub 530 and drive hub 545 may rotate in opposite directions, causing each motion magnet 520 and drive magnet 550 to rotate in opposite directions past each other as they are brought into proximity during a portion of their respective rotational paths.

In certain embodiments, the magnetic drive assembly 500 may have multiple rotating motion hubs 530 spaced around a single magnetic drive hub 545 in the same rotation plane, as shown in FIG. 6. Multiple motion hubs 530 may be spaced equidistantly around a drive hub 545 or in any other suitable configuration. Motion hubs 530 may be coupled individually to separate motion axles 560. In the example embodiment shown in FIG. 6, four motion hubs 530 are spaced equidistantly about the perimeter of a single drive hub 545. Two motion magnets 520 are attached to each of the four motion hubs 530, and four drive magnets 550 are attached to the drive hub 545. This configuration allows for approximately a four-fold increase in overall power output over a single motion hub/drive hub configuration (with the same amount of magnets per drive and motion hub, and the same size drive and motion hub) with little or no loss in efficiency. In the configuration shown, four motion magnets 520 enter acceleration fields 590 created by the four drive magnets 550 on the drive hub 545 substantially simultaneously. It is recognized, however, that various arrangements of one, two or multiple motion hubs and one, two or multiple magnetic drive hubs in the same rotation plane are possible. For example, there may be more or less than four motion hubs 530 and more or less than one drive hub 545.

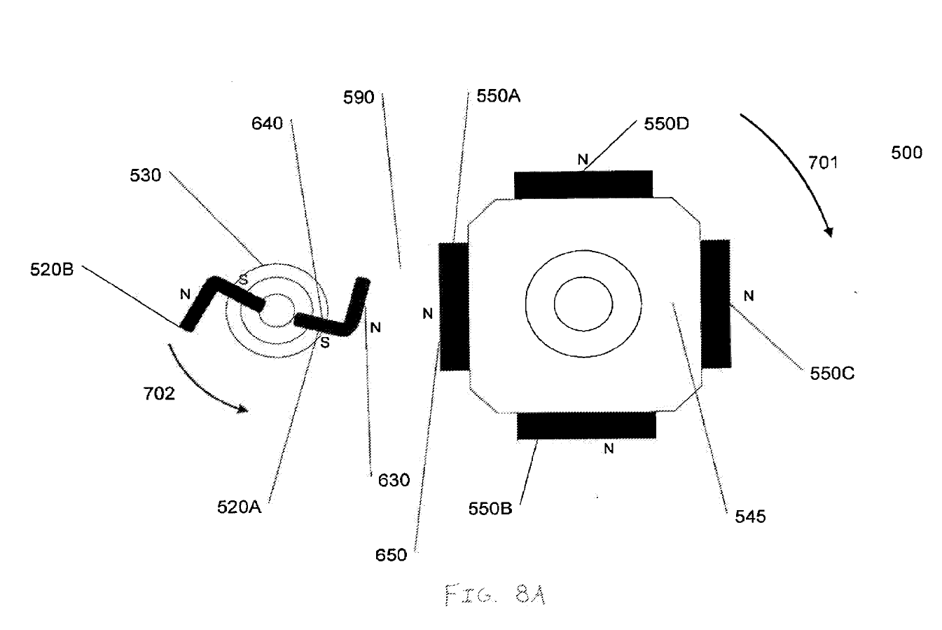

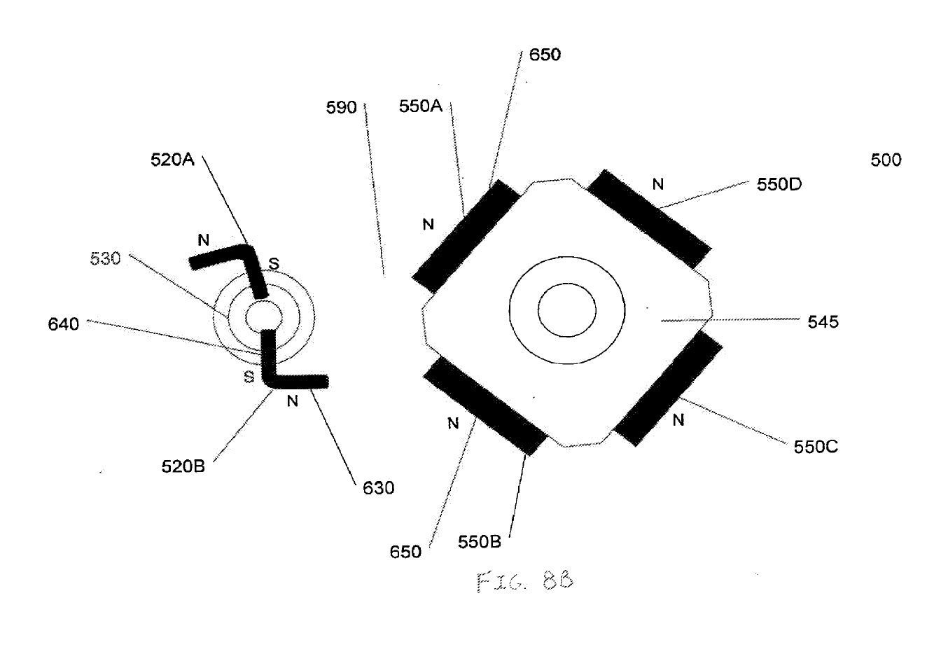

In another embodiment of the magnetic drive assembly of the present disclosure, shown in FIG. 7A, power and/or torque may be increased by adding motion hubs axially along a motion axle 560, such that multiple motion hubs may be present per motion axle, and rotate in generally parallel rotation planes to one another. In the example embodiment shown in FIG. 7A, four motion hubs 530 are located axially along motion axle 560. However, any appropriate amount of motion axle 560 output power and/or torque can be achieved by placing one, two, or more motion hubs on the motion axle. Typically, each motion hub 530 on a motion axle 560 is configured to rotate in the same rotation plane as one or more drive hubs 545.

Typically, one or more motion magnets 520 may be attached to each motion hub 530. Where more than one motion hub 530 is attached to a motion axle 560, the alignment of motion magnets 520 on each attached motion hub 530 may be the same or different as the alignment of the motion magnets on one or more of the other motion hubs attached to the same motion axle. In the embodiment shown in FIG. 7A, for example, motion magnets 520 on each motion hub 530 share substantially the same alignment as motion magnets on the other motion hubs of motion axle 560. In the embodiment illustrated in FIG. 7B, however, the alignment of motion magnets 520 on each motion hub 530 is different from the motion magnets on at least one other motion hub of motion axle 560.

Generally, where motion magnets 520 on two or more motion hubs 530 attached to same motion axle 560 share the same alignment, two or more motion magnets on the shared-alignment motion hubs will enter into acceleration fields at generally the same time. In other words, the shared-alignment motion hubs have a “synchronous” alignment. Where alignments of motion magnets 520 vary between two or more motion hubs 530 attached to the same motion axle 560, motion magnets on the varying-alignment or “offset”-alignment motion hubs can be configured so they generally do not enter acceleration fields at the same time. In this way, the number of motion magnets 520 in acceleration fields and the timing of entry into acceleration fields on a motion axle 560 at any one time may be adjusted to affect power and/or torque output, as described more fully below.

As stated above, FIG. 7A illustrates a synchronous alignment embodiment of the present disclosure. Multiple motion hubs 530 may be orientated on a motion axle 560 such that two or more or all of the motion hubs 530 rotate a motion magnet 520 into an acceleration field 590 at substantially the same time. Typically, drive hubs 545 and drive magnets 550 are arranged in a corresponding alignment to the motion hubs 530 and motion magnets 520, so that the multiple synchronous acceleration fields may be created. In the example synchronous alignment embodiment shown in FIG. 7A, two motion magnets 520 are equally spaced around the perimeter of each motion hub 530, and four drive magnets 550 are equally spaced around each of four corresponding drive hubs 545, although any suitable number of hubs, magnets per hubs, and magnet spacing configurations are possible. In such synchronous alignment embodiment, power and/or torque output of the motion axle 560 may have one or more output(s) ‘peaks,’ the peak outputs occurring where motion magnets 520 on successive motion hubs 530 synchronously exit acceleration fields. Power and/or torque output may be lower in the intervals between the times when motion magnets 520 are exiting acceleration fields.

FIG. 7B illustrates an example embodiment of varying, “offset” alignments, which may give a more constant output of torque and/or power. In offset alignment embodiments, the motion hubs 530 on the same motion axle 560 may be offset at one or more offset angles from one another, such that motion magnets 520 of one motion hub exit an acceleration field at different times than motion magnets 520 of another motion hub. This staggers the times at which motion magnets on the same motion axle 560 exit acceleration fields, imparting a more constant torque and/or power to the motion axle 560.

In some offset alignment embodiments, the alignment of one or more of a plurality of motion hubs 530 on the same motion axle 560 may be configured such that no motion magnets of any of the one or more motion hubs 530 enter acceleration fields in synchrony with each other. In other offset alignment embodiments, motion magnets 520 on one motion hub 530 may enter acceleration fields in synchrony with one or more of the motion magnets 520 on another motion hub 530 on the same motion axle 560, but be offset from one or more of the motion magnets 520 on yet another motion hub 530 on the same motion axle.

The particular offset alignment of motion hubs 530 attached to the same motion axle may be characterized by the alignment's “offset angles,” that is, the degree of offset between corresponding motion magnets 520 on adjacent motion hubs 530. The offset angle between adjacent motion hubs may or may not be the same between all adjacent motion hubs 530 on a motion axle 560.

The offset alignment of drive magnets 550 on adjacent drive hubs 545 on a drive axle 540 may also be characterized by its offset angles. Typically, drive magnets 550 on one or more drive hubs 545 can be arranged in a offset alignment on a drive axle 540 such that efficient and effective acceleration fields may be created with the corresponding motion magnets 520 on a motion hub 530. In some embodiments, the offset angle between adjacent drive hubs 545 on the same drive axle 540 may be the offset angle between the corresponding motion hubs on the motion axle 560, adjusted by a multiplier or other variable which is dependent on the gear ratio between the corresponding motion hubs 530 and drive hubs 545. For example, where a gear ratio between a corresponding drive hub and motion hub is denoted as d:m, then a typical multiplier for the offset angle, D°, for adjacent drive hubs on the drive axle may, in one example method, be approximated by D°=M° (d/m), where M° is the offset angle between corresponding adjacent motion hubs on the motion axle. Conversely, M°=D° (m/d) can be used to approximate a typical multiplier for the offset angle, M°, for adjacent motion hubs on the motion axle with respect to a known offset for corresponding adjacent drive hubs on the drive axle. For example, in the embodiment shown in FIG. 7B, the gear ratio is 1:2, i.e., four drive magnets 550 are attached to each drive hub 545, and two motion magnets 520 attached to each corresponding motion hub 530. The offset angle between adjacent drive hubs 545 is about 22.5°, and thus the offset angle between adjacent motion hubs 530 is about 45°. In the example embodiment FIG. 7B, all of the offset angles between adjacent drive hubs are the same, as well as all of the offset angles between adjacent motion hubs. However, it is recognized that, in some embodiments, not all offset angles between hubs on the motion or drive axles will be the same.

In the example offset alignment embodiment illustrated in FIG. 7B, the offset angle between corresponding motion magnets 520 is about 45°, but other suitable offset angles are possible. In a “helical” offset orientation, as is shown, each successive motion hub 530 is offset by the same offset angle in the same direction from the previous motion hub 530 on the motion axle 560, but other suitable alignments are possible, including but not limited to randomized offsetting, whereby each successive motion hub 530 may be offset from the previous motion hub by any offset, irrespective of the offset between any other two motion hubs along the same motion axle.

Offset alignments can give a more constant torque output than a completely synchronous alignment embodiment, such as that shown in FIG. 7A. Similarly, offset alignments where none of the motion hubs have the same alignment, may give a more constant torque than offset, “partially synchronous alignments,” where some of the motion hubs have the same alignment. In further embodiments as illustrated in FIG. 2, multiple motion axles, with one, two or multiple motion hubs positioned axially along the motion axles, may be added around the perimeter of a drive axle, which may have multiple drive hubs attached thereto.

Embodiments of the magnetic drive assembly may have a gearbox functionality, increasing or decreasing the gear ratios between an input drive axle 540 and output motion axle 560. This may be accomplished by changing the number of magnets on a drive hub 545 and/or motion hub 530 rotating in the same rotation plane. For instance, reducing the number of motion magnets 520 on motion hub 530 relative to the amount of drive magnets 550 on corresponding drive hub 545 may cause an increased RPM of the motion hub relative to the drive hub. Increasing the number of drive magnets 550 on a drive hub 545 relative to the amount of motion magnets 520 on corresponding motion hub 530 may also cause an increased RPM of the motion hub relative to the drive hub. In the example embodiment shown in FIG. 6, for example, the number of motion magnets 520 per motion hub 530 may cause the motion hubs 530 and motion axles 560 to rotate at twice the speed as the drive hub 545 and drive axles 540. However, various configurations of motion magnets and/or drive magnet are possible to achieve suitable reduced or increased gear ratios.

Because the motion hub 530 and drive hub 545 do not make contact with each other, an advantage of using the magnetic drive assembly of the present disclosure as a gearbox is that it generates little or no heat from friction, exhibits little mechanical wear, and requires little or no lubrication and, thus, may require much less maintenance or replacement costs than conventional gear assemblies in which the gears interlock. Whether or not an embodiment of the present disclosure has the same or other gear ratio between the output and input axles, an advantage of the present disclosure over motors with gears or other similar connections, is that properly spaced magnets (generally, evenly spaced around the drive hub 545 and motion hubs 530) can self-correct into the proper orientation and speed if the rotation speeds of the drive and motion hubs get out of phase. Under the same conditions, conventional gears or similar connections with interlocking parts may be expected to lock, jam or break, necessitating off-line time and repairs.

in some embodiments, as illustrated, motion magnets 520 may be generally “V,” “U,” or “A” shaped. Additionally, the motion magnets 520 and/or drive magnets 550 may further include magnetic shielding to appropriately redirect the magnetic force emanating from desired edges. That is, magnetic shielding may be used to redirect a magnetic field through the shield, similar to a conductor, so that the magnetic field has lessened or no influence on objects passing by the magnet or side of the magnet that has magnetic shielding. Magnetic shielding material is desirably material with magnetic permeability. That is, material that will allow magnetic flux within it. Materials with higher magnetic permeability provide better magnetic shielding than those materials with lower magnetic permeability. In one embodiment, the magnet shielding may be, but is not limited to, steel.

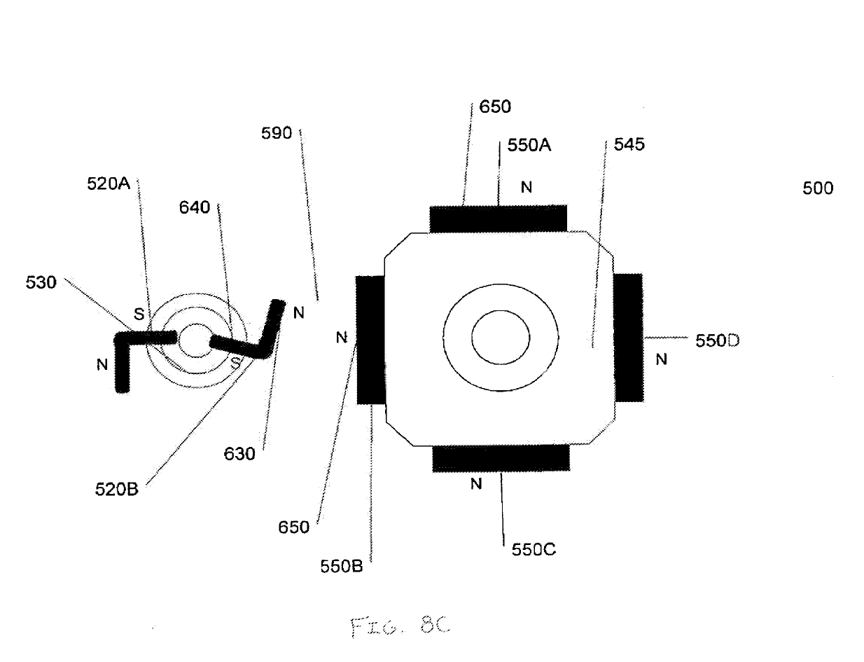

The operation of the magnetic drive assembly 500 will now be discussed with reference to FIGS. 8A-C. The drive magnets 550 have been numbered 550A, 550B, 550C and 550D for easier reference while describing the magnetic propulsion motor 500 in operation. Similarly, the motion magnets 520 that are visible in these drawings have been numbered 520A, and 520B.

Referring now to FIG. 8A, motion magnet 520A is at a “home” position, generally with side 630 at the midpoint of side 650 of drive magnet 550A, in the center of acceleration field 590. In this embodiment, the polarity of side 630 of motion magnets 520A and 520B is north and side 640 is south. Side 650 of drive magnet 550A has a north polarity, i.e., the same polarity as side 630 of motion magnet 520A. Motion hub 530 and drive hub 545 rotate in opposite directions. In this example embodiment, drive hub 545 rotates clockwise, as shown by arrow 701 and motion hub 530 rotates counterclockwise, shown by arrow 702. The rotation and direction of rotation of drive hub 454 is driven by a power source, such as, but not limited to wheel 202.

Motion magnets 520A-B and drive magnets 550A, D may have facing sides 630 and 650 all with the same polarity, i.e., all-north or all-south polarities. In some embodiments, the polarities of facing sides 630 and 650 may alternate, as described in U.S. Pat. No. 7,385,325, U.S. Pat. No. 7,777,377, and U.S. Publ. No. 2010-0156223. However, whenever sides 630 and 650 will directly face each other in an acceleration field, they should have the same polarity. This creates the repelling force to accelerate motion magnet 520A through and out of the acceleration field 590. This force causes motion magnets 520A-B and therefore rotating hub 530 to rotate about main axle 560.

The drive force rotating drive hub 545 clockwise causes drive magnet 550A to rotate away from the acceleration field 590 and 550B to rotate toward it, as shown in FIG. 8B. As can be seen from FIG. 8B, motion magnet 520A has rotated counterclockwise out of the acceleration field 590. At the same time, 520B begins to enter the area where the acceleration field 590 will be created. In this orientation, the acceleration field “window” is open, and the repulsion force between motion magnet 520B and drive magnets 550A and 550B is significantly lower. An acceleration field is once again created as motion magnet 520B is able to rotate into proximity to drive magnet 550B, which exert a repulsive force against each other.

Thus, motion magnet 520B can more easily enter the acceleration field as shown in FIG. 8C. At this position, drive magnet 550B edge 650, has rotated into close proximity to motion magnet 520B, edge 630, i.e., “home” position. As noted above, edge 650 and edge 630 have the same polarity. As the motion hub 530 and drive hub 545 continue to rotate in opposite directions between the orientations in FIGS. 8B and 8C, motion magnet 520B edge 630 is exposed to generally the full strength of the created acceleration field, between motion magnet 520B and drive magnet 550B.

As can be seen, the rotation directions of the motion hub 530 and drive hub 545 lengthens the time that the motion magnet 520B edge 630 spends in close proximity to the drive magnet 550B edge 650, generating significant repulsive force. Further, the repulsive force caused by the proximity of the same polarity on the drive magnet 550B edge 650 and motion magnet 520B edge 630 also causes the motion hub 530 to rotate further in a counterclockwise direction, imparting torque and/or power to motion axle 560.

The timing of the position of drive magnets 550 and motion magnets 520, thus described, provides for at least two resulting effects. First, an exiting motion magnet, e.g., motion magnet 520A, will be pushed away from the acceleration field created by an interaction with drive magnet 550A, while the next subsequent motion magnet, e.g., motion magnet 520B, which is entering the acceleration field area, faces a much lower repulsive force as it enters the acceleration field because drive magnets 550A and 550B are away from the acceleration filed area as motion magnet 520B enters. Backlash can be significantly avoided because the repulsive force of acting on a motion magnet 520 that is approaching an acceleration field generator 510 is significantly reduced in this manner.

With reference now back to FIG. 2, in one embodiment, the frame of the entire power drive 200 may be fixed to a moveable system by the use of, for example but not limited to, hydraulic or pneumatic lifts 212, which can be used to raise and lower the power drive. The lifts 212 or alternative suitable mechanism can assist in proper placement of the wheel 202 in the fluid flow for an optimum or desired amount of power. Also, lifting the system can provide easy access for any maintenance that may be desired or needed and as a safety shut-off procedure if any problems arise.

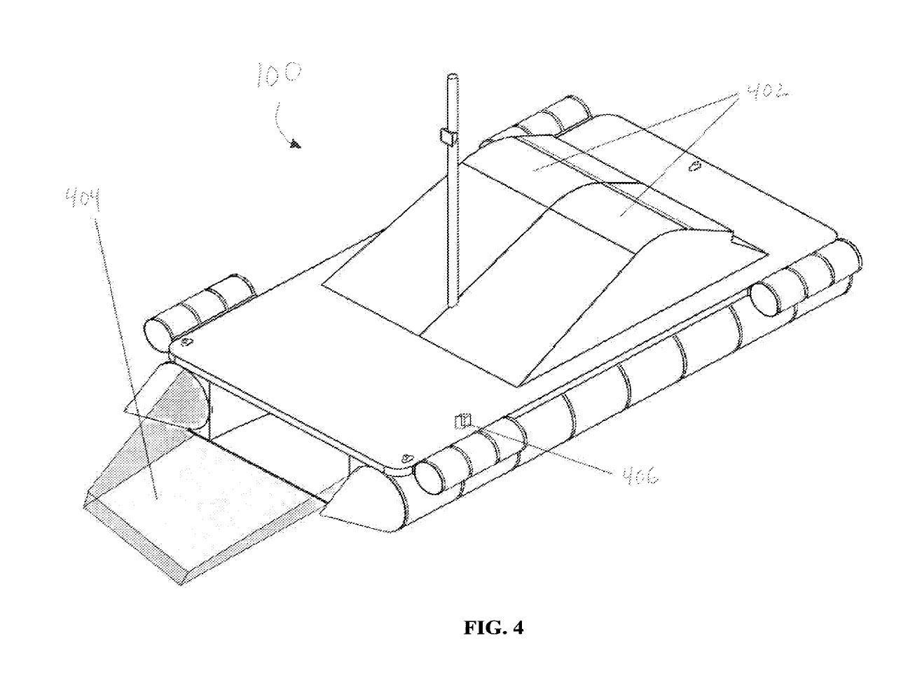

In some embodiments, portions of the magnetic drive assembly 204 may be configured for position below the fluid line, those portions may be configured to fit within the wells 110, as shown in FIG. 3. This can help prevent water from getting into the gearbox and generators of the power drive 200.

As shown in FIG. 3, the powertoon 100 may include a top deck 302, which can add structural integrity to the overall system. Furthermore, the top deck 302 may be part (e.g., the top part) of the acceleration chamber 106. The top deck 302 can also provide maintenance areas and space to house electronics and sensors. As shown in FIG. 3, the power drive 200, discussed above, may be generally supported by the powertoon 100, such that the wheel 202 can be rotated by the fluid flow through the acceleration chamber 106. In one embodiment, a portion of the power drive 200, including the generators 106, may be positioned above the top deck 302, although such configuration is not necessary.

An electronics and/or battery container 304 may be used to host any electrical components to convert DC to AC, if desired or necessary. The container 304 may also house, for example but not limited to, one or more batteries for backup power and/or auxiliary power for, but not limited to, navigation lights, bilge pumps, sensors, data acquisition, data transmissions, and GPS systems.

A mast 306 may be included for guiding the power line that can be run to shore, or other suitable location, for use or for running the power onto a power grid. The mast 306 can allow for disconnecting a tether for the power line and can be configured to provide sufficient strain relief for the power line.

In some embodiments, GPS and/or various other sensors 308 can be provided and may be used to, for example but not limited to, provide the position of powertoon 100 in relationship to the body of fluid, power production data, or environmental data. The sensors 308 can be used to relay power output and currents of the fluid. This information can help to determine if there is any problem with the system.

In some embodiments, the powertoon 100 may include stabilizing floats 310, which can be used to prevent capsizing of the powertoon or as backup floatation to the pontoons 102.

Turning to FIG. 4, the powertoon 100 may include covers 402, such as watertight covers, that can be used to protect the power drive 200, electronics, and other vital components from harmful exposure to the elements and may also provide proper ventilation and temperature control. The covers 402 may be made of any suitable material, such as any of the materials previously discussed herein.

In some embodiments, the powertoon 100 may have one or more debris screens 404 to prevent foreign objects from entering into the acceleration chamber 106 and/or contacting the wheel 202, but allowing the fluid to flow therethrough substantially without impedance. The screens 404 can also prevent fish or other live animals from entering, thereby protecting them from harm. The debris screens 404 may be a lattice or mesh screen, or any other suitable material for helping to prevent foreign objects from entering into the acceleration chamber 106 and/or contacting the wheel 202, but allowing the fluid to flow therethrough substantially without impedance.

In some embodiments, the powertoon 100 may include one or more bilge pumps 406 that may be used for keeping water out of, or away from, the power drive 200 and the wells 110. The bilge pumps 406 may alternatively or additionally be used as a draft adjustment system. More particularly, the bilge pumps 406 may be used to pump fluid in to or pump fluid out of the pontoons 102 and/or stabilizing floats 310 to adjust the height of the power drive 200 with respect to the position of the fluid for an optimum or desired performance.

Generally, in operation, the front of the powertoon 100 may act like a large scoop that catches the flowing fluid. The pontoons 102 can also be designed or configured to generally automatically maintain the powertoon 100 level in an optimal or desirable position. Upon entering the front of the powertoon 100, the fluid may be forced into a narrower channel, referred to herein as the fluid acceleration chamber 106, which in some embodiments, may function somewhat similar to, but not entirely the same as a Venturi tube. In the acceleration chamber 106, the bottom and the top of the acceleration chamber, along with the sides of the acceleration chamber, can force the water into a smaller area/volume, and thus increase its flow velocity. This accelerated flow can be controlled by the area/volume ratio of the acceleration chamber 106.

Once at its accelerated velocity, the fluid may flow into the wheel 202 to generate rotational energy. This energy can then be fed to the magnetic drive assembly 204 or other suitable drive assembly through a driveshaft connecting the wheel 202 and the magnetic or other drive assembly. The magnetic drive assembly 204 or other suitable drive assembly can then increase the rotational speed/energy to a suitable level for the generators 206. The magnetic drive assembly 204 or other suitable drive assembly can have multiple output shafts, where each shaft is then coupled with a generator 206, which can be either AC or DC. In addition, or alternatively, to magnets, this rotational speed increase can be achieved through, as some examples, belting or mechanical gearing. However, due to low efficiencies with belting or mechanical gearing, significant energy could be lost. Once the generators 206 are producing electricity, that electricity can be fed to an electrical control box 304 where it may be rectified and converted to a usable sine wave. Then, the electricity can travel in a power line up the mast 306 and ran above the fluid to land or other desirable location where it can be used or connected to a power grid.

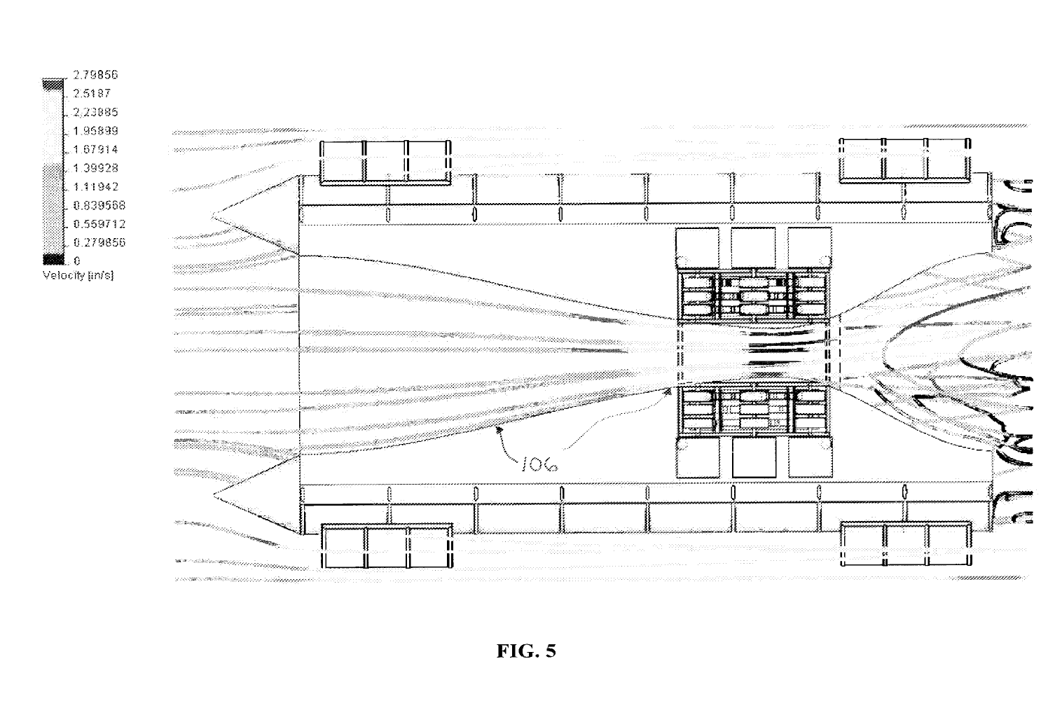

FIG. 5 illustrates flow through the acceleration chamber 106. As discussed above, the acceleration chamber 106, in some embodiments, may function somewhat similar to, but not entirely the same as a Venturi tube, wherein the flow area/volume is decreased. This change in area/volume increases the flow velocity at the point of the area/volume change. It is substantially at, or near, the point of highest velocity where the wheel 202 can be positioned to capture the flow energy. Downstream of the wheel 202, the flow area/volume can be returned to substantially its previous dimensions in order to not affect the flow of the fluid downstream of the powertoon 100.

By capturing a certain flow rate, Q, of the natural fluid flow, one can raise the velocity of the flow by changing the flow area:

Q=Aₘvₘ=Aₒᵤₜvₒᵤₜ

where Aᵢₙ is the initial cross-sectional area (e.g., at the entrance of the acceleration chamber 106), Aₒᵤₜ is the cross-sectional area at a point of flow acceleration (e.g., at a narrow point, or in some cases, the narrowest point, of the acceleration chamber 106), vᵢₙ is the fluid velocity at the location of Aᵢₙ (e.g., entering the acceleration chamber 106), and vₒᵤₜ is the fluid velocity at the location of Aₒᵤₜ (e.g., at a narrow point, or in some cases, the narrowest point, of the acceleration chamber 106, such as where it would contact the wheel 202). The velocity of the natural flow can be accelerated based on the ratio of the area:

$$\frac{{A}_{in}}{{A}_{out}} {v}_{in} = {v}_{out}$$

The kinetic power of the flow is given by:

$$P = \frac{1}{2} ρ {A}_{out} {v}_{out}^{3} = \frac{1}{2} ρ Q {v}_{out}^{2} = \frac{1}{2} ρ {Q ( \frac{{A}_{in}}{{A}_{out}} )}^{2} {v}_{in}^{2}$$

where ρ is density of the fluid. As an example only, and assuming a fluid flow of four miles per hour (mph), with an acceleration chamber having a 10:1 acceleration ratio, a velocity of 40 mph could theoretically be achieved. An acceleration ratio of 10:1 can be achieved, for example only, by having an Aᵢₙ of 10 ft² and an Aₒᵤₜ of 1 ft². Accordingly, using the above equation, and using the density of water as an example, the theoretical power generated could be about 266 kilowatts (kW). Assuming, for purposes of illustration only, that the acceleration chamber 106 has an efficiency of approximately 70%, the wheel 202 has an efficiency of approximately 80%, the magnetic drive assembly 204 has an efficiency of approximately 98%, and the generators 206 have an efficiency of approximately 85%, the anticipated power would be about 125 kW.

Capturing the natural kinetic energy of a fluid, such as but not limited to a river, stream, etc., using the various embodiments of a powertoon 100 of the present disclosure can generate renewable power without the need for expensive dams. Furthermore, capturing the natural flow of a fluid, such as but not limited to a river, stream, etc., has substantially little to no environmental impact. The abundance of such natural water flows, such as but not limited to rivers, streams, etc., provides a large amount of availability for a powertoon 100 according to the various embodiments of the present disclosure.

The power generation of a powertoon 100 according to the various embodiments of the present disclosure can be generally continuous and steady. Furthermore, a powertoon 100 according to the various embodiments of the present disclosure can be mobile and versatile, allowing for uses such as a residential generator, disaster relief aid, military generator, etc. The nature and size of a powertoon 100 may allow for quick and easy setup, relocation, and/or removal. The powertoon 100 can be portable and can be put into operation substantially anyplace that there is flowing water. The powertoon 100 is also ecologically sound.

A powertoon 100 according to the various embodiments of the present disclosure may be positioned in high flow areas of a fluid current flow and may be tethered to shore or anchored in position. Power cables may be strung from the mast to shore or any other local for consumption of the generated power. In further embodiments, the power from the various embodiments of a powertoon 100 herein may be stored, such as by using the system and method for storing wind energy described in U.S. Prov. Appl. No. 61/333,879, which is hereby incorporated by reference herein in its entirety.

Although the various embodiments of the present disclosure have been described with reference to preferred embodiments, persons skilled in the art will recognize that changes may be made in form and detail without departing from the spirit and scope of the present disclosure.

We claim:

1. An apparatus for generating power from a fluid current comprising:
a power drive assembly for converting the flowing energy of a fluid current into rotational energy and the rotational energy into electrical energy;
an acceleration chamber configured to increase an entering flow of fluid to an accelerated flow; and
one or more pontoons for supporting at least a portion of the power drive assembly in the acceleration chamber, such that the power drive assembly is positioned to receive the flowing energy of the accelerated flow.

2. The apparatus of claim 1, wherein the power drive assembly comprises at least one of a paddle wheel or Pelton wheel supported to receive the flowing energy of the accelerated flow.

3. The apparatus of claim 2, wherein the power drive assembly comprises a magnetic drive assembly operably coupled with the at least one of paddle wheel or Pelton wheel.

4. The apparatus of claim 1, wherein the acceleration chamber comprises an opening at a first end which narrows in cross-sectional area toward a second end, thus increasing the flow of fluid from the first end to the second.

5. The apparatus of claim 4, wherein the power drive assembly comprises means for transforming the flowing energy of the accelerated flow into rotational energy of a drive axis, at least a portion of the means for transforming supported to receive the flowing energy of the accelerated flow.

6. The apparatus of claim 5, wherein the power drive assembly further comprises a magnetic drive assembly operably coupled with the drive axis.

7. The apparatus of claim 6, wherein the magnetic drive assembly comprises a drive magnet and a motion magnet, the drive magnet and motion magnet, due to at least one of their attractive or repelling forces, working in conjunction to gear up the rotational energy of the drive axis.

8. The apparatus of claim 7, wherein the drive magnet is supported for rotation about the drive axis.

9. The apparatus of claim 8, wherein the motion magnet is supported for rotation about an output axis, the rotation of the motion magnet about the output axis driving the output axis.

10. The apparatus of claim 9, wherein the power drive assembly comprises a generator operably coupled with the output axis for generating the electrical energy.

11. A method for generating power from a fluid current comprising:
accelerating a flow of fluid to an accelerated flow;
positioning at least a portion of a power drive assembly within the accelerated flow, the power drive assembly configured for converting the flowing energy of a fluid current into rotational energy and the rotational energy into electrical energy; and
supporting the power drive assembly with pontoons, such that the power drive assembly may be floated on a moving body of fluid.

12. The method of claim 11, wherein the power drive assembly comprises at least one of a paddle wheel or Pelton wheel supported to receive the flowing energy of the accelerated flow.

13. The method of claim 12, wherein the power drive assembly comprises a magnetic drive assembly operably coupled with the at least one of paddle wheel or Pelton wheel.

14. The method of claim 11, wherein the acceleration chamber comprises an opening at a first end which narrows in cross-sectional area toward a second end, thus increasing the flow of fluid from the first end to the second.

15. The method of claim 11, wherein the power drive assembly comprises means for transforming the flowing energy of the accelerated flow into rotational energy of a drive axis, at least a portion of the means for transforming supported to receive the flowing energy of the accelerated flow.

16. The method of claim 15, wherein the power drive assembly further comprises a magnetic drive assembly operably coupled with the drive axis.

17. The method of claim 16, wherein the magnetic drive assembly comprises a drive magnet supported for rotation about the drive axis.

18. The method of claim 17, wherein the magnetic drive assembly comprises a motion magnet supported for rotation about an output axis.

19. The method of claim 18, wherein the drive magnet and motion magnet, due to at least one of their attractive or repelling forces, work in conjunction to gear up the rotational energy of the drive axis as output on the output axis.

20. The method of claim 19, wherein the power drive assembly comprises a generator operably coupled with the output axis for generating the electrical energy.

21. The method of claim 15, wherein the power drive assembly further comprises a magnetic drive assembly for gearing up the rotational energy of the drive axis by means of a magnetic acceleration field.
